(19) United States
(12) Patent Application Publication
(10) Pub. No.: US 2024/0237745 A1
(43) Pub. Date: Jul. 18, 2024

(54) AEROSOL PROVISION DEVICE

(71) Applicant: Nicoventures Trading Limited, London (GB)

(72) Inventor: Syd TAVERN, London (GB)

(21) Appl. No.: 18/563,715

(22) PCT Filed: May 24, 2022
(86) PCT No.: PCT/EP2022/064125

§ 371 Date: Nov. 22, 2023

(30) Foreign Application Priority Data
May 26, 2021 (GB) 2107483.6

(51) Int. Cl. A24F 40/465; A24F 40/20; H05B 6/36

(52) U.S. Cl. CPC A24F 40/465; A24F 40/20; H05B 6/36

(57) ABSTRACT

An aerosol provision device is described. The device generates an aerosol from aerosol-generating material. The device has a housing and a receptacle in the housing in which aerosol-generating material is received. An induction heating system heats aerosol-generating material when aerosol-generating material is received in the receptacle. The induction heating system also has a spiral induction coil. The receptacle extends through the spiral induction coil; and the spiral induction coil is movable in the housing relative to the receptacle.

### PRIORITY CLAIM

The present application is a National Phase Entry of PCT Application No. PCT/EP2022/064125 filed May 24, 2022, which claims priority to GB Application No. 2107483.6 filed May 26, 2021, each of which is herein incorporated by reference in their entirety.

### TECHNICAL FIELD

The present invention relates to an aerosol provision device. The present invention also relates an aerosol provision system comprising the aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, a material. The material may be an aerosol-generating material.

### SUMMARY

According to a first aspect of the present disclosure, there is provided an aerosol provision device for generating an aerosol from aerosol-generating material, the device comprising: a housing, a receptacle in the housing configured to receive aerosol-generating material; and an induction heating system for causing heating of aerosol-generating material when aerosol-generating material is received in the receptacle, the induction heating system comprising a spiral induction coil; wherein the receptacle extends through the spiral induction coil; and wherein the spiral induction coil is movable relative to the receptacle in the housing.

The spiral induction coil may be a flat spiral coil.

The device may comprise a movable carrier arranged to carry the spiral induction coil.

The movable carrier may comprise a plate and the flat spiral coil may be on a first side of the plate.

The movable carrier may comprise a substrate of a printed circuit board.

The device may comprise a coil adjustment mechanism arranged to move the movable carrier along the receptacle.

The receptacle may be elongate, and the spiral induction coil may be movable in a longitudinal direction along the receptacle.

The spiral induction coil may be movable between pre-defined positions.

The pre-defined positions may be spaced in a longitudinal direction along the receptacle relative to one another and/or in respective planes perpendicular to the longitudinal axis.

The device may comprise a locking mechanism configured to releasably secure the spiral induction coil in place.

The locking mechanism may be configured to releasably secure the coil when located at one of the pre-defined positions; and/or at any position along the length of the receptacle within a range of positions through which the coil is moveable.

The device may be configured to use the coil to generate inductive heating only when the coil is releasably secured by the locking mechanism.

The device may be configured to operate the coil only when the coil is stationary relative to the receptacle.

The induction heating system may comprise a heating element comprising heating material heatable by penetration with the varying magnetic field.

The heating element may be elongate and the heating element may extend through the spiral induction coil.

The heating element may protrude in the receptacle.

The heating element may protrude longitudinally from a distal end of the receptacle towards a proximal end of the receptacle.

The heating element may comprise a first heating element portion, which is elongate and protrudes in the receptacle, and a second heating element portion. The second heating element portion may be disc-like and extends laterally from the first heating element portion.

The receptacle may comprise the heating element.

The heating element may define a peripheral wall of the receptacle.

The heating element may define an interior surface of the receptacle and/or an exterior surface of the receptacle.

The heating element may be tubular.

The heating element may comprise a plurality of heating material portions.

The heating material portions may be spaced apart from one another in a longitudinal direction along the receptacle.

The heating element may extend along a longitudinal axis of the receptacle.

The receptacle may be free of heating material that is heatable by penetration with a varying magnetic field.

The housing may comprise a body defining the receptacle.

The body may be free of heating material that is heatable by penetration with a varying magnetic field.

The spiral induction coil may be configured to be movable manually by a user.

The spiral induction coil may be configured to be movable according to a pre-determined program.

The device may further comprise a helical coil. The helical coil may be configured so as to not be movable relative to the receptacle and/or the housing.

According to second aspect of the present disclosure, there is provided a system comprising an article including aerosol-generating material; an aerosol provision device comprising: a receptacle configured to receive aerosol-generating material, and an induction heating system operable to induce a varying magnetic field comprising a planar induction coil; and a heating element including heating material which is heatable by the spiral induction coil via penetration with a varying magnetic field.

The article may comprise the heating element.

The device may comprise the heating element.

The heating element may form at least a part of the receptacle.

The heating element may define an interior surface of the receptacle and/or an exterior surface of the receptacle.

The heating element may define the receptacle.

The heating element may protrude into the receptacle.

The heating element may protrude longitudinally from a distal end of the receptacle towards a proximal end of the receptacle.

The heating element may comprise a plurality of heating material portions.

The heating material portions may spaced apart from one another in a longitudinal direction.

The aerosol provision device of the second aspect may have any and/or all of the features of the aerosol provision device of the first aspect.

### BRIEF DESCRIPTION OF THE DRAWINGS

FIG. 1 shows an aerosol provision system with an aerosol provision device and an article received within the device;

FIG. 2 shows a schematic cross-sectional view of the system shown in FIG. 1;

FIG. 3 shows an inductor coil of the system shown in FIG. 1; and

FIGS. 4A-C show a schematic cross-section of a part of the device shown in FIG. 2, with an inductor coil in different operating conditions.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

In certain embodiments, the aerosol-generating material may be provided as a plurality of portions of aerosol-generating material. In other words, the article may comprise a plurality of portions of aerosol-generating material. In certain embodiments, the plurality of portions of aerosol-generating material may be provided as a singular or unitary body; in other words, each portion of the plurality of portions of aerosol-generating material may also be described as a region or a zone of aerosol-generating material within the overall body of aerosol-generating material. In certain embodiments, the plurality of portions of aerosol-generating material may be provided as a series of discrete or separate bodies of aerosol-generating material; in other words, each portion of the plurality of portions of aerosol generating material may also be described as distinct or apart from the remaining portions of the plurality of portions of aerosol-generating material. Providing the plurality of portions of aerosol-generating material in an article allows any of the aerosol provision systems described herein to generate aerosol from the article in a controlled manner. For instance, certain flavors or strengths of aerosol for inhalation may be chosen for release. Furthermore, certain portions of the aerosol-generating material provided on an article may be heated in a predetermined order or heating pattern such that aerosols of differing compositions may be released in a predetermined order or pattern.

Induction heating systems generally comprise an electromagnet and a device for passing a varying electric current, such as an alternating electric current, through the electromagnet. The varying electric current in the electromagnet produces a varying magnetic field. The varying magnetic field penetrates the electrically-conductive object suitably positioned with respect to the electromagnet, generating eddy currents inside the object. The object has electrical resistance to the eddy currents, and hence the flow of the eddy currents against this resistance causes the object to be heated by Joule heating, which may also be known as ohmic, or resistive heating. It has been found that, when the electrically conductive object is in the form of a closed electrical circuit, magnetic coupling between the object and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating. In cases where the heater comprises ferromagnetic material such as iron, nickel or cobalt, heat may also be generated by magnetic hysteresis losses in the heater, i.e. by the varying orientation of magnetic dipoles in the magnetic material as a result of their alignment with the varying magnetic field.

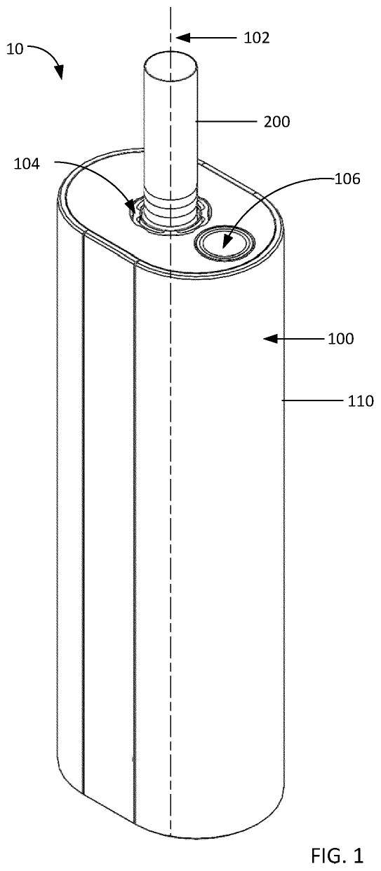

FIG. 1 shows an aerosol provision system 10. The system 10 includes an aerosol provision device 100 for generating an aerosol from aerosol-generating material, a replaceable article 200 comprising aerosol-generating material. The device 100 can be used to heat the replaceable article 200 comprising the aerosol generating material, to generate an aerosol or other inhalable medium which can be inhaled by a user of the device 100.

The aerosol provision device 100 shown in FIG. 1 comprises a housing 110 which surrounds and houses various components of the device 100. The housing 110 is elongate. The device 100 has an opening 104 in one end, through which the article 200 can be inserted for heating by the device 100. The article 200 may be fully or partially inserted into the device 100 for heating by the device 100.

The device 100 may comprise a user-operable control element 106, such as a button or switch, which operates the device 100 when operated, e.g. pressed. For example, a user may activate the device 100 by pressing the switch 106.

The device 100 defines a longitudinal axis 102, along which an article 200 may extend when inserted into the device 100. The opening 104 is aligned on the longitudinal axis 102.

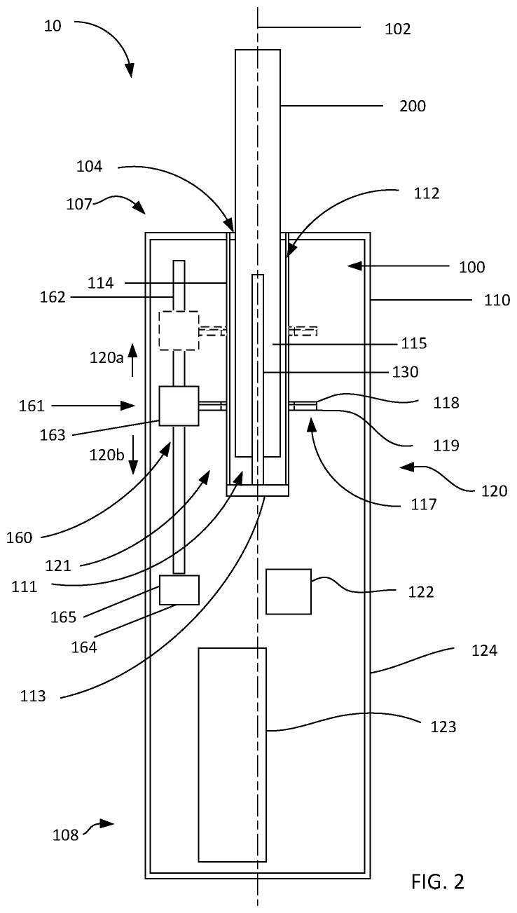

FIG. 2 is a schematic illustration of the aerosol generating system 10 of FIG. 1, showing various components of the device 100. It will be appreciated that the device 100 may include other components not shown in FIG. 2.

As shown in FIG. 2, the device 100 includes an apparatus 120 for heating aerosol-generating material. The apparatus 120 includes an aerosol generator 121, a controller (control circuit) 122, and a power source 123. The device 100 comprises a body assembly 124. The body assembly 124 may include a chassis and other components forming part of the device. The aerosol generator 121 acts as an induction heating system.

The aerosol generator 121 is configured to heat the aerosol-generating material of an article 200 inserted into the device 100, such that an aerosol is generated from the aerosol generating medium. The power source 123 supplies electrical power to the aerosol generator 121, and the aerosol generator 121 converts the supplied electrical energy into heat energy for heating the aerosol-generating material.

In embodiments, the controller 122 is partially or wholly electronic and/or is partially or wholly implemented in software and/or firmware. In embodiments, the control mechanism 122 comprises or is partially or wholly comprised within a processor.

The power source 123 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source 123 may be electrically coupled to the aerosol generator 121 to supply electrical power when required and under control of the controller 122 to heat the aerosol generating material. The control circuit 122 may be configured to activate and deactivate the aerosol generator 121 based on a user operating the control element 106. For example, the controller 122 may activate the aerosol generator 121 in response to a user operating the switch 106.

The end of the device 100 closest to the opening 104 may be known as the proximal end (or mouth end) 107 of the device 100 because, in use, it is closest to the mouth of the user. In use, a user inserts an article 200 into the opening 104, operates the user control 106 to begin heating the aerosol generating material and draws on the aerosol generated in the device. This causes the aerosol to flow through the article 200 along a flow path towards the proximal end of the device 100.

The other end of the device furthest away from the opening 104 may be known as the distal end 108 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 102.

The aerosol generator 121 may comprise various components to heat the aerosol generating material of the article 200 via an inductive heating process. Induction heating is a process of heating an electrically conducting heating element by electromagnetic induction. An induction aerosol generator may comprise an inductive element, for example, one or more inductor coils, and a device for passing a varying electric current, such as an alternating electric current, through the inductive element. The varying electric current in the inductive element produces a varying magnetic field. The varying magnetic field penetrates a heating element, acting as a susceptor, suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 120 includes a heating chamber 111 configured and dimensioned to receive the article 200 to be heated. The heating chamber 111 defines a heating zone 115. In the present example, the article 200 is generally cylindrical, and the heating chamber 111 is correspondingly generally cylindrical in shape. However, other shapes would be possible. The heating chamber 111 is formed by a receptacle 112. The receptacle 112 includes an end wall 113 and a peripheral wall 114. The end wall 113 acts as a base of the receptacle 112. The end wall closes the distal end of the heating chamber 111.

The heating chamber 111 is defined by the inner surfaces of the receptacle 112. The receptacle 112 comprises a generally tubular member. The receptacle 112 extends along and around and substantially coaxial with the longitudinal axis 102 of the device 100. However, other shapes would be possible. The receptacle 112 (and so heating zone 115) is open at its proximal end such that an article 200 inserted into the opening 104 of the device 100 can be received by the heating chamber 111 there-through. The receptacle 112 is closed at its distal end by the end wall 113. The receptacle 112 may comprise one or more conduits that form part of an air path. In use, the distal end of the article 200 may be positioned in proximity or engagement with the end of the heating chamber 111. Air may pass through the one or more conduits forming part of the air path, into the heating chamber 111, and flow through the article 200 towards the proximal end of the device 100.

The receptacle 112 is, in the depicted embodiment, a generally elongated cavity having a longitudinal axis which accommodates the generally elongated article 200. The receptacle 112 is configured to, in use, receive the article 200. The receptacle 112 is open at its proximal end such that the article 200 can be inserted into the receptacle 112. The receptacle 112 is closed at its distal end by the end wall 113. The receptacle 112 is configured to receive a part or a portion of the article 200 as shown in FIG. 2. In embodiments, the receptacle 112 receives the entire body of the article 200. In other embodiments receptacle 112 is shaped and arranged to receive other shapes of article 200. The longitudinal axis of the receptacle may or may not be co-axial with the longitudinal axis 102 of the device 100.

The receptacle 112 is defined by a body. The body is free of heating material heatable by penetration by a varying magnetic field. In embodiments, the body is formed from an insulating material. For example, the body may be formed from a plastic, such as polyether ether ketone (PEEK). Other suitable materials are possible. The receptacle 112 may be formed from such materials to ensure that the assembly remains rigid/solid when the aerosol generator 121 is operated. Using a non-metallic material for the receptacle 112 may assist with restricting heating of other components of the device 100. Forming the receptacle 112 from a rigid material may aid in support of other components. Other arrangements for the receptacle 112 would be possible. For example, in an embodiment the end wall 113 is defined by part of the aerosol generator 121. In embodiments, the receptacle 112 comprises material that is heatable by penetration with a varying magnetic field, as will be described below.

In some embodiments, the body is fixed within the housing 110 and/or integral with the housing 110, but in other embodiments the body is removable from the housing 110 (e.g. for cleaning). In embodiments, the body is generally tubular, as depicted, but may be any other suitable shape, e.g. having one or more protrusions, indents, or flanges in alternative embodiments.

As illustrated in FIG. 2, the aerosol generator 121 comprises a heating element 130. The heating element 130 is configured to heat the heating zone 115. In embodiments the heating zone 115 is defined by a portion of the receptacle 112 or the extent of the receptacle 112.

The heating element 130 is heatable to heat the heating zone 115. The heating element 130 is an induction heating element. That is, the heating element 130 comprises a susceptor that is heatable by penetration with a varying magnetic field. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The aerosol generator 121 comprises a magnetic field generator. The magnetic field generator is configured to generate one or more varying magnetic fields that penetrate the susceptor so as to cause heating in the susceptor. The magnetic field generator includes an inductor coil arrangement 117. The inductor coil arrangement 117 comprises an inductor coil 118, acting as an inductor element.

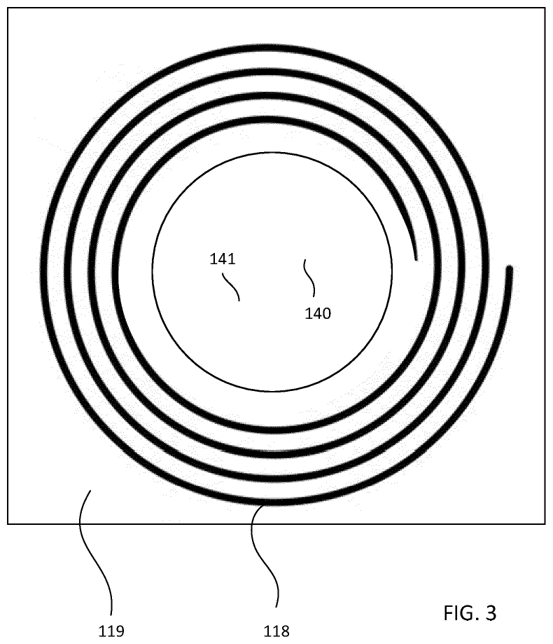

The inductor coil 118 is shown in FIG. 3. The inductor coil 118 is a two-dimensional spiral on a surface of a printed circuit board (PCB) 119. The PCB 119 acts as a substrate and is substantially planar. The substrate supports the coil 118. The inductor coil 118 is defined by a film. In this embodiment, the substrate 119 is a non-electrically conductive support. That is, the substrate is an electrical insulator. In embodiments, the plate is made from FR-4, which is a composite material composed of woven fibreglass cloth with an epoxy resin binder that is flame retardant. Other suitable materials may be used. In other embodiments, the support substrate may be omitted. The inductor coil 118 may take a different configuration. In embodiments, the inductor coil arrangement 117 comprises two or more inductor coils. The two or more inductor coils in embodiments are disposed adjacent to each other and may be aligned co-axially on opposing major sides of the substrate 119.

The inductor coil 118 is an electrically conductive coil configured to conduct a varying electrical current. The coil 118 may be formed, for example, by depositing, printing, etching, chemically or mechanically bonding. In an embodiment, coil 118 is formed by printing the electrically-conductive material onto a side of the board during manufacture of the PCB, and then removing (such as by etching) selective portions of the electrically-conductive material so that patterns of the electrically-conductive material in the form of the coil 118 remain on the board. In an embodiment the coil 118 is provided on the board in any other suitable way, such as by being pre-formed and then attached to the plate.

In some embodiments, the substrate 119 is not a PCB. For example, it may be a layer or sheet of material such as resin or adhesive, which may have dried, cured, or solidified.

The inductor coil 118 is a generally circular coil. In other embodiments, the inductor coil 118 may have a different shape, such as generally square, rectangular or elliptical. In some such embodiments, the inductor coil 118 may be manufactured using an additive manufacturing technique, such as 3D printing. In this embodiment, adjacent spaced portions of the inductor coil 118 are regularly spaced. In other embodiments, such portions of the inductor coil 118 may not be regularly spaced.

An aperture 140 is defined by the inductor coil 118. In the present arrangement the aperture 140 is defined in the axial centre of the inductor coil 118. The aperture 140 is configured to receive the receptacle 112. The aperture 140 extends from a proximal extent of the inductor coil 118. The aperture 140 is defined by the innermost side of the inductor coil 118. The aperture corresponds to the shape of the inductor coil 140. The aperture 140 is coaxial with the axis 102. In embodiments in which the receptacle 112 is offset from the axis, the aperture is offset.

An opening 141 is formed in the substrate 119. The opening 141 is aligned with the aperture 140. The opening 141 is configured to receive the receptacle 112 therein. The receptacle 112 extends through the inductor coil 118, and through the opening 141.

In embodiments, the magnetic field generator includes further inductor coil arrangements. These may be identical to or different from the first inductor coil arrangement 117. The provision of multiple coils may allow for a more complex temperature profile along the length of an article 200 in use.

Where the heating element 130 extends through the inductor coil 118 the heating element 130 is susceptible to varying magnetic flux on both a proximal side and a distal side of the inductor coil 118. The heating element 130 may therefore be susceptible to varying magnetic flux on both sides of the inductor coil 118.

The heating element 130 extends in the heating zone 115. The heating element 130, acting as a protruding element, protrudes in the heating zone 115. The heating element 130 upstands from the base of the receptacle 112. The heating element 130 is spaced from the peripheral wall 114 of the receptacle 112. The heating assembly 121 is configured such that when an article 200 is received by the heating chamber 111, the heating element 130 extends into a distal end of the article 200. The heating element 130 is positioned, in use, within the article 200. The heating element 130 is configured to heat aerosol generating material of an article 200 from within, and for this reason is referred to as an inner heating element.

The heating element 130 extends into the heating chamber 111 from the distal end of the heating chamber 111 along the longitudinal axis 102 of the device (in the axial direction). In embodiments the heating element 130 extends into the heating chamber 111 spaced from the axis 102. The heating element 130 may be off-axis or non-parallel to the axis 102. Although one heating element 130 is shown, it will be understood that in embodiments, the aerosol generator 121 comprises a plurality of heating elements. Such heating elements in embodiments are spaced from but parallel to each other.

In embodiments, the heating element 130 comprises a first susceptor portion and a second susceptor portion. The individual susceptor portions may be spaced from each other in the direction of the longitudinal axis 102.

In embodiments, heating element 130 comprises homogeneous, or substantially homogeneous, material. In embodiments, heating element 130 comprises one or materials selected from the group consisting of: an electrically-conductive material, a magnetic material, and a magnetic electrically-conductive material. In embodiments, the heating element 130 comprises a metal or a metal alloy. In embodiments, the heating element 130 comprises one or more materials selected from the group consisting of: aluminium, gold, iron, nickel, cobalt, conductive carbon, graphite, plain-carbon steel, stainless steel, ferritic stainless steel, steel, molybdenum, silicon carbide, copper, and bronze.

The inductor coil 118 is disposed external to the receptacle 112. The inductor coil 118 encircles the heating zone 115. The inductor coil 118 extends around at least a portion of the heating element 130, acting as a susceptor. The inductor coil 118 is configured to generate a varying magnetic field that penetrates the heating element 130. The inductor coil 118 is arranged coaxially with the heating chamber 111 and longitudinal axis 102. In some examples, in use, the coil 118 is configured to heat the heating element 130 to a temperature of between about 200° C. and about 350° C., such as between about 240° C. and about 300° C., or between about 250° ° C. and about 280° C.

The aerosol generator 121 comprises a coil adjustment mechanism assembly 160. The coil adjustment mechanism assembly 160 is configured to move the coil in the housing. The coil adjustment mechanism assembly 160 comprises a coil carrier 161. The coil adjustment mechanism assembly 160 translates the inductor coil 118 relative to the receptacle.

The PCB 119 forms part of the coil carrier 161. The coil carrier 161 comprises a carrier member 163 on an elongate rail 162 configured to support the coil carrier 161 and to maintain the position of the coil arrangement 117 relative to the receptacle 112 in directions transverse to the longitudinal axis 102.

In embodiments, the coil carrier comprises a plurality of inductor coil arrangements. In embodiments, a plurality of coil carriers 161 with respective inductor coil arrangements 117 are provided.

The rail 162 is parallel to the axis 102. The rail 162 extends distally within the device further than the receptacle 112 such that the coil carrier can be moved along the rail 162 so as to position the coil arrangement 117 distally of the receptacle 112. In addition, a gap between the proximal end of the rail 162 and the proximal end of the device 100 maintains a minimum distance between the coil arrangement 117 and the proximal end of the device. The rail may comprise one or more screw threads or teeth. The rail may be splined. It will be understood that various arrangements may be used to cause the inductor coil 118 to translate in a linear movement, and so a detailed description will be omitted.

Only one rail 162 is shown in FIG. 2, but in embodiments a plurality of rails are provided, such as two rails on opposing sides of the receptacle 112 and/or two rails lying in a shared plane with the axis 102. In embodiments with two or more rails 162, the rails may be spaced equal distances from the axis 102 (and/or the receptacle 112) as one another, or different distances. In embodiments with more than two rails, they may be arranged to encircle the axis 102 and/or the receptacle 112. In embodiments with multiple carriers, each carrier may be mounted on a respective set of one or more rails, or the carriers may share rails.

In embodiments, the rail 162 extends distally along only the length, or only a portion of the length, of the receptacle 112 and as such coil arrangement 117 is confined so as to move along the axis only within the length, or a portion of the length, of the receptacle 112. In embodiments, the rail 162 is not parallel to the axis 102.

The coil adjustment mechanism assembly 160 comprises an actuator 165 configured to drive the carrier 161, and thereby the coil arrangement 117, to move along the axis 102. Examples of suitable actuators include, but are not limited to; screw mechanisms, rack and pinion arrangements, telescoping linear actuators, magnetic drives, and push-pull actuators. The actuator may comprise the rail e.g. as a rack in a rack and pinion arrangement. The actuator may comprise one or more electric motors.

The controller 122 is configured to operate the actuator to move the coil carrier 161 proximally and distally along the longitudinal axis 102, as indicated by arrows 120a and 120b. As such, when an article 200 is received within the receptacle 112, the controller is configured to move the coil 118 along at least a portion of the length of the article 200.

In embodiments, the controller 122 provides direct control of the position of the coil arrangement 117 to a user. In some of such embodiments, the device 100 comprises one or more user-operable position control elements (such as a user interface comprising one or more touch screens, keypads, switches, sliders, scroll wheels, or the like) in order to allow a user to directly control the longitudinal position and/or movement of the coil arrangement 117. In an embodiment, the user-operable position control elements may function as an alternative actuator to the actuator 165 by being configured such that operation of the control element drives the motion of the coil carrier 161. For example, in embodiments the device comprises a slider (not shown) that is mechanically linked, either directly or indirectly, to the coil carrier 121 such that when a user manipulates the slider, the coil is also moved.

In embodiments where multiple carriers are provided, the controller 122 is configured to operate actuators to move each carrier proximally and distally along the longitudinal axis. In embodiments, different subsections of the receptacle 112 are associated with different carriers configured to move only within that subsection. In some embodiments the multiple carriers are configured to be movable independently of each other and/or to be movable in concert.

In embodiments, the controller 122 is configured to move the coil 118 along the length of the receptacle 112 according to one or more pre-determined programs. For example, in an embodiment the control mechanism 122 is configured and/or programmed so as to control, or cause, movement of the coil 118 from the distal end of the receptacle 112 towards the proximal end of the receptacle 112, or vice-versa. As another example, a pre-determined program directs the control mechanism 122 to move the coil in a continuous fashion between two points, so as to oscillate between the two and generate a ‘smoother’ temperature increase over a wider area.

In embodiments, the user-operable position control elements are configured to allow a user to select a program of the pre-determined programs. In embodiments, the user-operable position control elements are configured to allow a user to modify such pre-determined programs and/or implement a customised program.

In embodiments, the controller 122 behaves as or comprises a selector, operable to permit the selection of the one or more portions of the aerosol-generating material of the article 200, from a plurality of portions of the aerosol-generating material, for heating by the heating system 121 when the article 200 is received in the receptacle 112.

In certain embodiments, the selector is operable to permit the selection of one or more portions of a plurality of portions of the receptacle 112, where the one or more portions of the receptacle 112 correspond to one or more portions of the aerosol-generating material of the article 200 when the article 200 is received in the receptacle 112. In this way, the desired one or more portions of the aerosol-generating material of the article 200, which have been chosen for heating by the heating system 121 when the article 200 is received in the receptacle 112, may be selected indirectly by selecting the one or more portions of the receptacle 112 that geometrically correspond to the one or more portions of the aerosol-generating material when the article 200 is received in the receptacle 112. The selection can thus, in certain embodiments, be based on a known geometric relationship between the article 200 and the receptacle 112 of the device 100.

In other examples, the selector operates in a pre-defined manner once an article 200 is received in the receptacle 112 and, optionally, at the instigation of a user. For instance, the selector may be activated, once an article 200 is received in the receptacle 112, to select particular portions of the aerosol-generating material for heating in a certain order. In some embodiments, the article 200 includes an identifier, in which the identifier is operable to communicate the type, or model, of article 200 to the device 100 when the article 200 is received in the receptacle 112. The identifier may communicate to the device 100 information that indicates how, or in what order, particular portions of the aerosol-generating material of the article 200 are to be heated. In other embodiments, a user may communicate to the non-combustible aerosol provision device 200, for instance through user-operable elements, information that indicates how, or in what order, particular portions of the aerosol-generating material of the article 200 are to be heated. In other embodiments still, the device 100 is pre-loaded with information that indicates how, or in what order, particular portions of the aerosol-generating material of the article 200 are to be heated. For example, the information may be imputed to the device 100 when manufactured or when an order is placed by a product supplier.

In embodiments the controller 122 is configured to control, and/or cause, movement of the coil based on and/or in response to the selection(s) made by the selector.

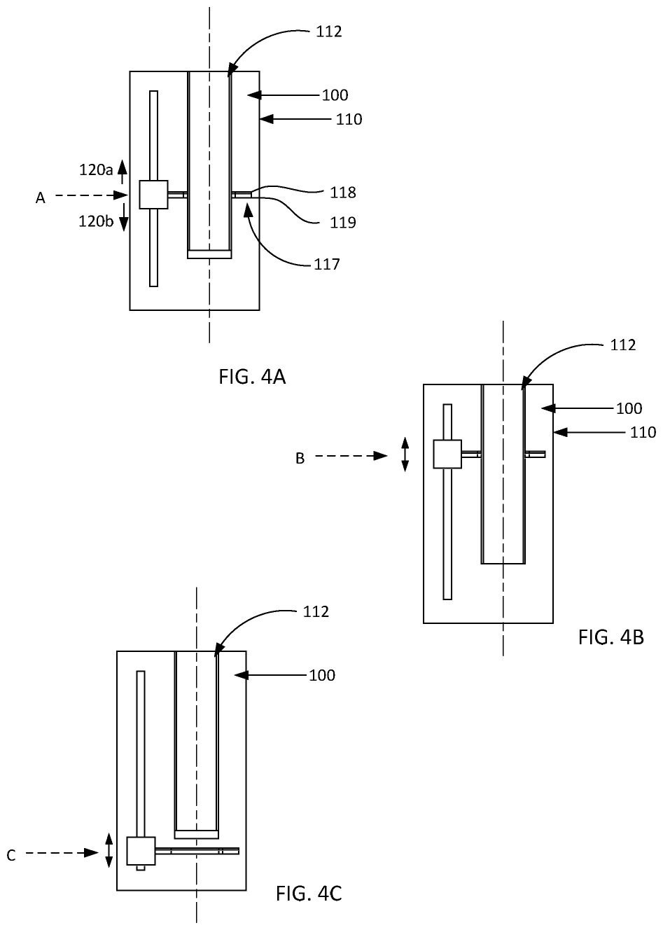

FIG. 4A shows the receptacle area of device 100 as shown in FIG. 2. In FIG. 4A the carrier 161 is located at a position A such that the coil arrangement 117 encircles the receptacle 112.

FIG. 4B shows the same receptacle area of the device 100 as in FIG. 4A, where the carrier 161 has been moved to a second position B such that the coil arrangement 117 also encircles the receptacle 112, as in position A.

FIG. 4C shows the same receptacle area of the device 100 as in FIGS. 4A-B, where the carrier 161 has been moved to a position C such that the coil arrangement 117 does not encircle the receptacle 112.

In an embodiment with reference to FIGS. 4A-4C a plurality of pre-set heating positions (A and B) are provided along the length of the receptacle 112, and a further pre-set inactive position (C) is placed distally of the receptacle. In alternative embodiments, all positions are active positions, and the coil 118 may only move along the receptacle 112 and past neither the proximal nor distal end.

In embodiments, a locking mechanism is provided to engage when the coil 118 is moved into any of these pre-set positions, so as to hold the coil 118 in place. In some embodiments, there is no locking mechanism other than that provided to engage at the pre-set positions. In embodiments, the device 100 includes control circuitry configured to allow operation of the induction heating system only when the coil 118 is disposed in a pre-set position. In embodiments, the device 100 is configured to prevent operation of the induction heating system when the coil 118 is in the pre-set inactive position (118E).

By allowing operation of the induction heating system only when the coil 118 is correctly positioned (as defined by the pre-set heating positions) the device 100 may ensure that zones of aerosol-generating material which are heated to an operating temperature in a session of use do not overlap with each other or that they overlap only within an acceptable extent. As such, switching to a ‘new’ position may result in a ‘fresher’ aerosol being provided to a user.

Further, by providing a position in which the coil 118 cannot be operated, the device 100 can reliably be prevented from accidental activation when placed in e.g. a pocket, rucksack, or handbag.

In the above described embodiments the heating element 130 is an inner susceptor. That is, the heating element protrudes into the heating chamber and is arranged to be received by the article.

In another embodiment the heating element is an outer susceptor. In such a configuration, the heating element may be a generally tubular member extending along and substantially coaxial with the longitudinal axis 102. The heating element may extend at least partially around an axial portion of the heating chamber. The heating element forms part of the receptacle 112. The heating element extends continuously around the entire circumference of the heating chamber 111, or only partially extend around the chamber. For example, one or more discontinuities, e.g. holes, gaps or slots, may be provided in the heating element. The heating element may be configured and dimensioned to extend around an article received by the heating chamber. The heating element may thus be positioned, in use, around an article. The heating element may thus be configured to heat aerosol generating material of the article 200 from outside, and for this reason be referred to as an outer heating element.

The heating element may have a circular cross section, e.g. corresponding a circular cross section of the article 110. Other cross sectional shapes would be possible. In embodiments, the heating element is co-axial with the coil arrangement 117; in alternative embodiments, the heating element 130 is not co-axial with the coil arrangement 117; in further embodiments the heating element 130 has a longitudinal axis that is parallel to, but off-set from, the longitudinal axis of the coil arrangement 117.

The base wall is disposed at an end of the tubular member. The outer heating element may form the tubular member at one end. The base wall in such embodiments defines the end of the heating zone 115.

The heating element forms an interior surface of the receptacle 112.

In the embodiments described above, the heating element 130 is fixedly connected to the device 100 such that it extends within and/or around the heating zone at a fixed position with respect to the housing. In these embodiments, the heating element 130 extends into or around the article 200 when the article 200 is received by the heating zone 115.

In other embodiments the heating material is provided within an article 200 that is to be inserted into the device 100. In embodiments, the heating element 130 is comprised within a substrate upon which aerosol-generating material is supported. In embodiments, such a substrate comprises a plurality of susceptor elements or portions, each associated with one or more discrete portions of aerosol-generating material disposed on the substrate. In embodiments, the heating element takes the form of an elongate rod, a generally planar sheet, a blade, or any other suitable shape. In embodiments, the heating element 130 is, in use, fixed, or secured relative to the receptacle 112. In embodiments the heating element 130 is embedded within aerosol-generating material. In embodiments the heating element 130 is located on an outside surface of the article and/or on an outermost edge of a portion of aerosol-generating material.

In these embodiments, the heating element may be moveable with respect to the receptacle. In these embodiments, the heating element may extend within the heating zone when the article 110 is received by the heating zone.

In addition to the movable coil described above, the device 100 may, in embodiments, further include a one or more coils not configured to move relative to the housing 110 and/or the receptacle 112 (i.e. static coil(s)). In embodiments the static coil takes the form of a helical coil surrounding a portion of the receptacle.

By providing a static coil positioned over a portion of the receptacle 112, in addition to a movable coil, the device may be enabled to provide heating along, for example, a majority portion of the receptacle, and therefore provides flexibility in use of the device with various types of article/aerosol-generating material.

In embodiments, the coil adjustment mechanism assembly 160 comprises a locking mechanism 164 configured to hold the carrier 161 in place. In some embodiments, the locking mechanism 164 is configured to automatically engage when the user-operable position control element is not being operated. In an additional, or alternative, embodiment, a user-operable element may be provided to engage and/or dis-engage the locking mechanism 164. This user-operable element is in embodiments one of the user-operable position control elements used to provide direct control of the position of the coil 118 by the user, but in other embodiments it is a further additional element. In embodiments, the device 100 provides an indication to the user as to whether the locking mechanism 164 is engaged. Further, in embodiments, the device 100 provides feedback (e.g. audio, visual, tactile) to the user when the locking mechanism 164 engages and/or disengages.

In embodiments, the device 100 comprises one or more indicators for indicating the position of the coil 118 to a user. In embodiments the indicators are positioned on an outside of the housing 110 such that they correspond approximately to the longitudinal position of the coil 118. In embodiments the indicators comprise a plurality of individual indicators, such as LED lights, or a single indicator configured to move in the longitudinal direction along with the coil 118. In embodiments, position of the coil 118 is indicated to a user via a display. In embodiments, position of the coil 118 is indicated to the user in terms relative to the article.

By indicating the position of the coil 118 to a user, the user may be able to determine the approximate time remaining in a use session, for example if the coil 118 travels steadily along the receptacle 112 according to a pre-determined program. The user may also be able to determine if/when a change in aerosol may be imminent, for example when a coil 118 will soon begin to heat a different composition of aerosol-generating material.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, means, etc, other than those specifically described herein. In addition, this disclosure may include other inventions not presently claimed, but which may be claimed in future.

1. An aerosol provision device for generating an aerosol from aerosol-generating material, the device comprising:
a housing
a receptacle in the housing configured to receive aerosol-generating material; and
an induction heating system for causing heating of aerosol-generating material when aerosol-generating material is received in the receptacle, the induction heating system comprising a spiral induction coil;
wherein the receptacle extends through the spiral induction coil; and
wherein the spiral induction coil is movable in the housing relative to the receptacle.

2. The device of claim 1, wherein the spiral induction coil is a flat spiral coil.

3. The device of claim 1, comprising a movable carrier arranged to carry the spiral induction coil.

4. The device of claim 3, wherein the movable carrier comprises a plate and the flat spiral coil is on a first side of the plate; and/or wherein the movable carrier comprises a substrate of a printed circuit board.

5. (canceled)

6. The device of claim 3, comprising a coil adjustment mechanism arranged to move the movable carrier along the receptacle.

7. The device of claim 1, wherein the receptacle is elongate, and the spiral induction coil is movable in a longitudinal direction along the receptacle.

8. The device of claim 7, wherein the spiral induction coil is movable between pre-defined positions.

9. (canceled)

10. The device of claim 1, wherein the device is configured to operate the coil when the coil is stationary relative to the receptacle.

11. The device of claim 1, wherein the induction heating system comprises a heating element comprising heating material heatable by penetration with the varying magnetic field.

12. (canceled)

13. The device of claim 11, wherein the heating element protrudes in the receptacle.

14. The device of claim 11, wherein the receptacle comprises the heating element.

15. (canceled)

16. The device of claim 11, wherein the heating element is tubular.

17. The device of claim 11, wherein the heating element comprises a plurality of heating material portions.

18. (canceled)

19. The device of claim 1, wherein the receptacle is free of heating material that is heatable by penetration with a varying magnetic field.

20. An aerosol provision system comprising:
an article including aerosol-generating material;
an aerosol provision device comprising
a receptacle configured to receive aerosol-generating material, and
an induction heating system operable to induce a varying magnetic field comprising a planar induction coil;
wherein the receptacle extends through the planar spiral induction coil; and
wherein the planar induction coil is movable relative to the receptacle; and
a heating element including heating material that is heatable by penetration with the varying magnetic field.

21. The system of claim 20, wherein the article comprises the heating element.

22. The system of claim 20, wherein the device comprises the heating element.

23. The system of claim 22, wherein the heating element forms at least a part of the receptacle.

24. (canceled)

25. The system of claim 22, wherein the heating element protrudes into the receptacle.

26. The system of claim 20, wherein the heating element comprises a plurality of heating material portions.

27. (canceled)
